(19) United States
(12) Patent Application Publication
(10) Pub. No.: US 2018/0374066 A1
(43) Pub. Date: Dec. 27, 2018

(54) Systems and Methods for Use in Facilitating Transactions to Payment Accounts

(71) Applicant: MASTERCARD INTERNATIONAL INCORPORATED, Purchase, NY (US)

(72) Inventors: Nitin Shrivastava, Stamford, CT (US); Joseph Damon Hayes, Montclair, NJ (US)

(21) Appl. No.: 15/631,487

(22) Filed: Jun. 23, 2017

(51) Int. Cl. G06Q 20/10; G06Q 20/36; G06Q 20/04; G06Q 20/34; G06Q 20/12; G06Q 30/06; G06Q 20/40

(52) U.S. Cl. CPC G06Q 20/10; G06Q 20/36; G06Q 20/04; G06Q 20/401; G06Q 20/12; G06Q 30/0633; G06Q 20/351

(57) ABSTRACT

Systems and methods are provided for use in facilitating transactions through virtual applications. One exemplary method includes receiving, via an application programming interface (API), from a user, an identification of a transaction for a product at a merchant, and soliciting from the user a designator for a funding user to fund the transaction where the designator is indicative of a virtual application associated with the funding user. The method also includes compiling a purchase option for the product including parameters for the transaction where the parameters include a delivery option for the product but not a payment account credential for funding the transaction, and transmitting, via the virtual wallet, the purchase option to the funding user. The method further includes, in response to approval of the purchase option by the funding user, providing a payment account credential associated with the virtual wallet, via the API, to the merchant.

### FIELD

The present disclosure generally relates to systems and methods for use in facilitating transactions by transacting users, based on options submitted to the transacting users by originating users and presented to the transacting user through virtual applications.

### BACKGROUND

This section provides background information related to the present disclosure which is not necessarily prior art.

Merchants are known to offer various different products (e.g., goods and services, etc.) for sale to consumers. The products may be offered through virtual merchant locations, for example, in which consumers or others add products to shopping carts, as an initial action toward purchasing the products from the virtual merchant locations. From the shopping carts, consumers are then known to proceed to purchase the products in the shopping carts, or the consumers may save the products for purchase later, or even, save the products to wish lists, which are, in turn, circulated to one or more other consumers of the products. Amazon™ online merchant, for example, offers a wish list feature, in which certain products may be added and then shared from one consumer to another (e.g., via email, etc.).

Later, consumers, in turn, are known to purchase the products with payment accounts, from the shopping carts or wish lists, etc. In so doing, the consumers typically present payment devices to the merchants, where the payment devices are associated with the payment accounts. The payment devices may include, for example, credit cards or debit cards. In addition, the payment devices may include smartphones associated with electronic wallets, or e-wallets (sometimes referred to as virtual wallets, etc.). Regardless of form, upon receipt of the payment devices, the merchants, via point-of-sale terminals, generate and transmit to issuers of the corresponding payment accounts authorization requests relating to the product purchases to confirm that the payment accounts have sufficient funds and/or credit to fund the transactions. If the requests are approved, the merchants continue in the transactions and permit the consumers to leave with the products (or otherwise facilitate delivery of the products to the consumers).

It is also known that payment accounts may have multiple authorized users, who may use the payment accounts to fund different transactions with the merchants. For example, spouses may be authorized users of the same payment accounts.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in facilitating transactions to payment accounts through virtual wallets;

FIG. 2 is a block diagram of a computing device that may be used in the exemplary system of FIG. 1;

FIG. 3 is an exemplary method that may be implemented in the system of FIG. 1 for use in facilitating a transaction to a payment account associated with a consumer through use of a virtual wallet;

FIGS. 4 and 5 are exemplary interfaces that may be used in the system of FIG. 1 and/or the method of FIG. 3 and that may be presented to an originating consumer to facilitate a transaction to a payment account; and

FIG. 6 is an exemplary interface that may be used in the system of FIG. 1 and/or the method of FIG. 3 and that may be used to display a purchase option to a transacting consumer for a product.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Consumers often use payment accounts to fund transactions for products at merchants (e.g., for goods, services, donations, utilities, etc.). When multiple consumers are involved (e.g., friends, spouses, family members, etc.), one consumer (e.g., an originating consumer, etc.) may communicate, via electronic mail (email) or text message, for example, with another consumer (e.g., a transacting consumer, etc.) to identify a desired product and request that the other consumer perform a transaction for the product. Uniquely, the systems and methods herein permit originating consumers to send options for products to transacting consumers, through virtual wallets associated with the transacting consumers. In particular, for example, upon identifying a desired product at a merchant, an originating consumer requests an option be sent to a transacting consumer for the product. In turn, the merchant contacts an option engine, which solicits a designator of the transacting consumer (in connection with the option request). Upon receipt of the designator, the engine identifies a virtual wallet associated with the transacting consumer and sends the option thereto. The transacting consumer, in turn, is able to view the option, and if desired, select the option, which enables the transacting consumer to interact with the merchant and pay for the product, using payment account credentials provisioned to the transacting consumer's virtual wallet. In this manner, the originating consumer may be able to precisely identify a desired or suggested product for purchase, for example, or other item requiring payment to the merchant, with the transacting consumer then being able to conveniently decide to purchase the product and/or otherwise make payment to the merchant, or not, for example, via his/her virtual wallet. As such, a convenient and/or efficient mechanism for facilitating payment account transactions is provided.

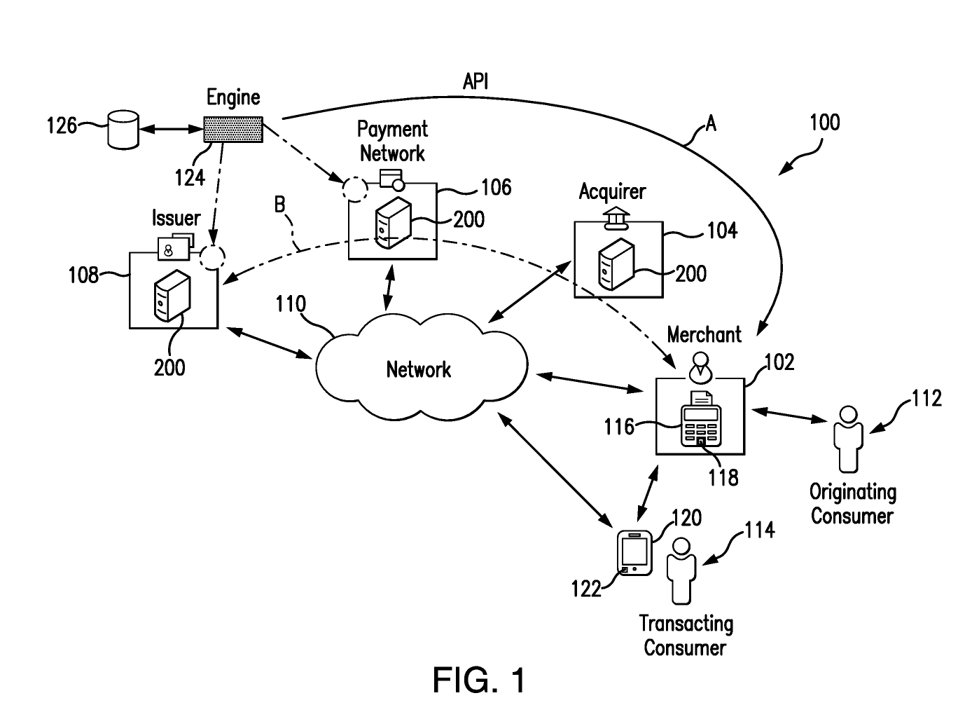

FIG. 1 illustrates an exemplary system 100, in which the one or more aspects of the present disclosure may be implemented. Although the system 100 is presented in one arrangement, other embodiments may include systems arranged otherwise depending, for example, on a manner in which transactions are processed to payment accounts, types of merchants involved in the payment account transactions, etc.

In the illustrated embodiment, the system 100 generally includes a merchant 102, an acquirer 104 associated with the merchant 102, a payment network 106, and an issuer 108 configured to issue payment accounts to consumers, each coupled to (and in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the payment network 106 to the acquirer 104 and the issuer 108 and, separately, the public Internet, which is accessible as desired to the merchant 102, the payment network 106, the issuer 108, and one or more various consumers in the system 100 (e.g., consumers 112 and 114, etc.), etc.

The merchant 102 in the system 100 may include any desired entity associated with products (e.g., associated with goods, services, donations, utilities, etc.) and configured to accept transactions via virtual wallets. As an example, the merchant 102 may include an entity generally associated with offering products for sale to consumers, such as consumers 112 and 114, in exchange for payment. In addition, or alternatively, the merchant 102 may include an entity to which payments are directed (whether in exchange for a product or not), such as, for example, a charity entity, where payments from consumers (such as consumers 112 and 114) to the merchant 102 may be considered donations, etc. Regardless, and as will be described more hereinafter, in association with such products, the merchant 102 is configured to offer options for the products to the consumers to facilitate performance of corresponding transactions by the consumers for the products. And, in connection therewith, the merchant 102 may accept payments for products at one or more merchant locations (e.g., at a brick-and-mortar location, etc.), and/or through one or more virtual locations (e.g., through a network-based application (e.g., a website, etc.), etc.).

The merchant 102 includes a terminal 116 (at its physical location(s)), which may include a point-of-sale, or POS, terminal or other computing device. The terminal 116 includes executable instructions, referred to herein as an application 118, which cause the terminal 116 to operate as described below. In particular, for example, the terminal 116 is configured to identify options for products (e.g., options to purchase goods or services, options to give donations, etc.), as selected by consumers. Such identification is based on inputs/selections at the terminal 116, by the consumers (e.g., manual inputs, product scans, etc.), of the merchant 102 (or potentially of another merchant), of one or more products associated with the merchant 102, of a particular charity associated with the merchant 102, of a donation, etc. The terminal 116 is also configured in some embodiments, at least in part, to perform as a conventional POS terminal, by totaling selected products for a given transaction and an amount to be paid (with tax as applicable), by facilitating payment (e.g., via cash through use of a cash register, via a payment device reader, etc.), and by providing a receipt for the transaction, etc. With that said, the terminal 116 is generally configured to perform one or more operations described herein generally in coordination with the application 118 (even if the application 118 is not specifically referenced), although this is not required in all embodiments.

As indicated above, the illustrated system 100 includes the consumers 112 and 114. As generally used herein, the consumer 112 is an originating consumer, who shops at the merchant 102, for example, and identifies products to be purchased from the merchant 102. Conversely, the consumer 114 is a transacting consumer (or funding user) who often is responsible for initiating and/or providing payment to the merchant 102, for example, for the products identified by the originating consumer 112. In one example, the originating consumer 112 may include a spouse of the transacting consumer 114. In another example, the transacting consumer 114 may include a parent of the originating consumer 112. In still another embodiment, the originating consumer 112 may include a friend or other acquaintance of the transacting consumer 114. Regardless, the originating consumer 112 is generally a person desiring and/or suggesting (to the transacting consumer 114) to purchase a particular product from and/or to make a donation (or other payment) to the merchant 102, and the transacting consumer 114 is a person ultimately deciding whether or not to make payment to the merchant 102 for the particular product (e.g., a decision maker, a permission giver, and/or a decision contributor, etc.).

The transacting consumer 114 is associated with a payment account issued by the issuer 108. In addition, the transacting consumer 114 is associated with a communication device 120, which in the illustrated embodiment generally includes a portable communication device such as a smartphone, a tablet, etc. The communication device 120 includes executable instructions, referred to herein as a virtual wallet 122, that cause the communication device 120 to perform the various operations described herein. In at least one embodiment, the virtual wallet 122 may include a virtual wallet such as, for example, PayPass® from MasterCard®, Apple Pay® from Apple®, PayWave® from Visa®, etc., or other suitable virtual wallet offered by the payment network 106, by the issuer 108, or by other entities. In connection therewith, upon installing the virtual wallet 122 to the communication device 120, the consumer 114 is generally prompted to register his/her payment account (as issued to the consumer 114 by the issuer 108) to the virtual wallet 122 (and provide various payment account credentials, such as, for example, a primary account number (PAN), a card verification codes (CVC), the expiration date, etc.), for subsequent use as described herein (e.g., for use in provisioning his/her payment account to the virtual wallet 122, for use in performing transactions to the payment account through the virtual wallet 122, etc.). With that said, when the communication device 120 is described as configured to perform various operations herein, it should be appreciated that it may be doing so generally in coordination with the virtual wallet 122 (even if the virtual wallet 122 is not specifically referenced), or not. While not shown, the originating consumer 112 may also be associated with a communication device at which a similar virtual wallet is installed.

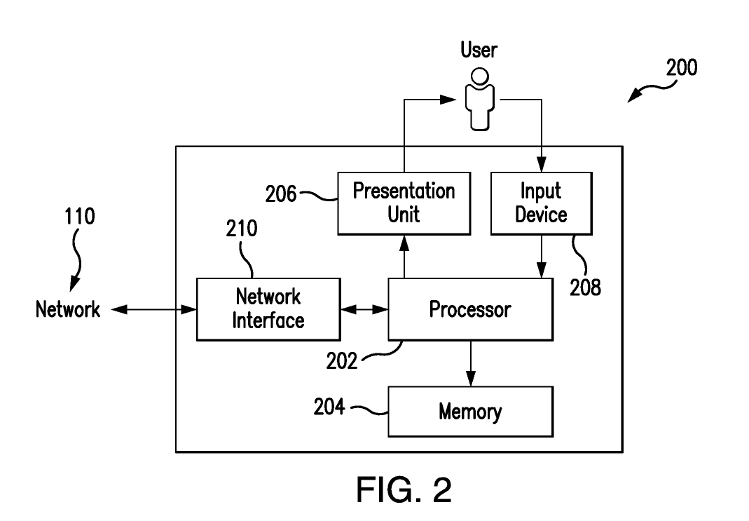

FIG. 2 illustrates an exemplary computing device 200 that can be used in the system 100. The computing device 200 may include, for example, one or more servers, workstations, personal computers, POS terminals, web servers, laptops, tablets, smartphones, etc. In addition, the computing device 200 may include a single computing device, or it may include multiple computing devices located in close proximity or distributed over a geographic region, so long as the computing devices are specifically configured to function as described herein. In particular, in the exemplary system 100 of FIG. 1, each of the acquirer 104, the payment network 106, and the issuer 108 are illustrated as including, or being implemented in, computing device 200, coupled to the network 110. In addition, each of the terminal 116 at the merchant 102 and the communication device 120 associated with the transacting consumer 114 may also be considered a computing device consistent with computing device 200. That said, the system 100 should not be considered to be limited to the computing device 200, as described below, as different computing devices and/or arrangements of computing devices may be used in other embodiments. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, payment credentials, options for products, product/donation descriptions, links to products/donations (and/or merchant network-based applications), and/or other types of data (and/or data structures) suitable for use as described herein. Furthermore, in various embodiments, executable instructions may be stored in the memory 204 for execution by the processor 202 to cause the processor 202 to perform one or more of the operations described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In addition in the exemplary embodiment, the computing device 200 includes a presentation unit 206 that is coupled to (and is in communication with) the processor 202 (however, it should be appreciated that the computing device 200 could include output devices other than the presentation unit 206, etc.). The presentation unit 206 outputs information (e.g., options, etc.), either visually or audibly, to a user of the computing device 200 such as, for example, to the transacting consumer 114, to users associated with other parts of the system 100, etc. And, various interfaces (e.g., as defined by network-based applications, short message service (SMS) messages, emails, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

The computing device 200 also includes an input device 208 that receives inputs from the user (i.e., user inputs) such as, for example, requests for option selections, etc. The input device 208 is coupled to (and is in communication with) the processor 202 and may include, for example, a keyboard, a pointing device, a mouse, a stylus, a touch sensitive panel (e.g., a touch pad or a touch screen, etc.), a product scanner, another computing device, and/or an audio input device. Further, in various exemplary embodiments, a touch screen, such as that included in a tablet, a smartphone, or similar device (e.g., the communication device 120, etc.), behaves as both a presentation unit and an input device.

In addition, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC) adapter, a Bluetooth adapter, etc.), a mobile network adapter, or other device capable of communicating to/with one or more different networks, including the network 110. Further, in some exemplary embodiments, the computing device 200 may include the processor 202 and one or more network interfaces (including the network interface 210) incorporated into or with the processor 202.

Referring again to FIG. 1, the system 100 includes an option engine 124, which is configured, by executable instructions, to perform the operations described herein. In the illustrated embodiment, the option engine 124 is provided as a separate part of the system 100 and in communication with the payment network 106 and/or the issuer 108, for example. As such, the option engine 124 may be considered a computing device consistent with computing device 200. Alternatively, in various embodiments, the option engine 124 may be incorporated, at least partly or entirely, into the payment network 106 and/or the issuer 108 (and their representative computing devices 200), as indicated by the dotted lines extending from the option engine 124 in FIG. 1. But again, regardless of whether incorporated or not, the option engine 124 is coupled to and/or is in communication with the payment network 106 and/or the issuer 108 to perform one or more of the operation described herein (e.g., for communicating with the virtual wallet 122, etc.). That said, in some embodiments the option engine 124 may include (or may be associated with) a virtual wallet platform configured to enable virtual wallets (e.g., the virtual wallet 122, etc.) and/or coordinate with multiple different virtual wallets as described herein (e.g., regardless of whether or not provided by the wallet platform, etc.) (e.g., provide payment tokens or otherwise enable payment account transactions with the virtual wallet 122, etc.). This may allow interoperable communication from the option engine 124 to one or more different virtual wallets (and, thereby potentially providing a marketplace among the different virtual wallets associated with the wallet platform of the option engine 124).

In general in the system 100, the option engine 124 is configured to expose a service to the merchant 102, as an application programming interface (API), which may be called by the terminal 116 and/or other terminals associated with the merchant 102 (or by a network-based application (e.g., a website, etc.) associated with the merchant 102), to provide for funding of the transaction through one or more virtual wallets (e.g., associated with the originating consumer 112 and/or the transacting consumer 114, etc.). In particular, the API is called to facilitate sending of one or more options to the transacting consumer 114 (and other transacting consumers), as described herein. As such, through the API, the terminal 116, for example, and the option engine 124 are able to communicate, as described herein.

In particular, when the originating consumer 112 decides on a product (or identifies a desired product), for example, to send to the transacting consumer 114, the originating consumer 112 identifies the product to the terminal 116 (e.g., via an input to the terminal 116, etc.) and/or other information related to the purchase of the product (e.g., delivery instructions, etc.). In addition, the originating consumer 112 may provide an instruction to the terminal 116 to fund the transaction with a virtual wallet (e.g., either with his/her virtual wallet or with someone else's wallet, etc.). This may be done prior to or after providing delivery instructions for the product (e.g., an instruction for in-store pickup, a shipping address, etc.) (e.g., directly to the merchant 102, via the option engine 124 as described below, etc.). While the above is described in connection with interaction of the originating consumer 112 with the terminal 116 of the merchant 102, it should be appreciated that the same also applies to interaction of the originating consumer 112 with a network-based application associated with the merchant 102 (e.g., at a computing device 200 accessible by the originating consumer 112 but potentially separate from the merchant 102, etc.).

In turn, in connection with use of a virtual wallet to fund the transaction, the terminal 116 is configured (by the application 118) to call the API, as indicated in FIG. 1 by the line A. The terminal 116 is configured to then solicit from the originating consumer 112, through one or more interfaces, and via the API, a designator indicative of the transacting consumer 114 and his/her virtual wallet 122 (e.g., a phone number, an electronic mail (or email) address, etc.) (e.g., when the originating consumer 112 selects to fund the transaction with the transacting consumer's virtual wallet 122, etc.). Upon receipt of the designator from the terminal 116 (via the one or more interfaces), the option engine 124 is configured to compile an option, based on the identified product, and to transmit the option to the transacting consumer 114 at the communication device 120 (and specifically at the virtual wallet 122) based on the designator for the transacting consumer 114. In so doing, the option engine 124 may identify the virtual wallet 122 for the transacting consumer 114 in a data structure 126 associated with the option engine 124 (e.g., stored in memory 204 of the option engine 124, stored elsewhere in the system 100, etc.). For example, when the transacting consumer 114 registers to the virtual wallet 122 (e.g., when the transacting consumer 114 installs the virtual wallet 122 at his/her communication device 120, etc.), the transacting consumer 114 enters contact information such as, for example, his/her phone number, email address, etc. (and/or other information relating to the transacting consumer 114). The virtual wallet 122 is configured to then communicate such information to the option engine 124 (e.g., via the payment network 106, the issuer 108, etc.); and the option engine 124 is configured to store the information in association with an application ID for the virtual wallet 122 in the data structure 126. Thus, through the designator for the transacting consumer 114, the option engine 124 is configured to identify the virtual wallet 122 for the transacting consumer 114 in the data structure 126.

The communication device 120 is configured, via the virtual wallet 122, to then indicate receipt of the option (e.g., by a tone, a vibration, etc.) to the transacting consumer 114. And, in response to an input from the transacting consumer 114, the communication device 120 is configured to launch the virtual wallet 122 and to present the option to the transacting consumer 114 through the virtual wallet 122, for example, by way of a link to a network-based application (e.g., website, etc.) associated with the merchant 102, etc. If the option is selected by the transacting consumer 114 (e.g., if the consumer 114 selects the link, etc.), the communication device 120 is configured to cause the network-based application to display at the communication device 120 in the form of an interface (e.g., via a web browser, etc.), to the transacting consumer 114. The interface may include a description of the product identified/selected by the originating consumer 112, an indication of the merchant 102, an indication of the originating consumer 112, etc., and/or may include a shopping cart with the product included therein (broadly, the interface may include a complete “offer” for the transacting consumer 114 to purchase the product, except for payment account credentials to fund the purchase). Then, upon input from the transacting consumer 114 to provide payment for the product (e.g., selection of a “buy now” input, etc.), the network-based application, and more generally, the merchant 102, is configured to facilitate a purchase transaction for the product, funded by the consumer's payment account via the virtual wallet 122.

In one example transaction for a product (be it for a good, a service, a donation, a utility, etc.) by the transacting consumer 114 (e.g., when the transacting consumer 114 selects the buy now input, etc.), the merchant 102 (e.g., via the terminal 116, via a network-based application associated with the merchant 102, etc.) is configured to retrieve (and/or receive) the payment account credentials for the consumer's payment account from the virtual wallet 122, and to communicate an authorization request for the transaction to the acquirer 104 via the network 110, generally consistent with path B in FIG. 1. The authorization request may include, for example, a PAN for the consumer's payment account and an amount of the transaction, etc. The acquirer 104, in turn, communicates the authorization message with the issuer 108, through the payment network 106 (via the network 110), for authorization of the transaction. The issuer 108 then determines if the consumer's payment account is in good standing and if sufficient credit/funds to complete the transaction is associated with the payment account. In this example, if the issuer 108 approves/accepts the transaction, another authorization message (and, more specifically, an authorization reply) is provided back to the merchant 102 authorizing the transaction, and the merchant 102 completes the transaction. The credit line or funds associated with the consumer's payment account, depending on the type of payment account, is then decreased by the amount of the transaction/payment, and the charge is posted to the payment account. The transaction is later cleared and settled by and between the merchant 102 and the acquirer 104 (in accordance with a settlement arrangement, etc.), and by and between the acquirer 104 and the issuer 108 (in accordance with another settlement arrangement, etc.).

Conversely, if the issuer 108 declines the transaction, an authorization message (and, more specifically, an authorization reply) is provided back to the merchant 102 declining the transaction, and the merchant 102 can stop the transaction.

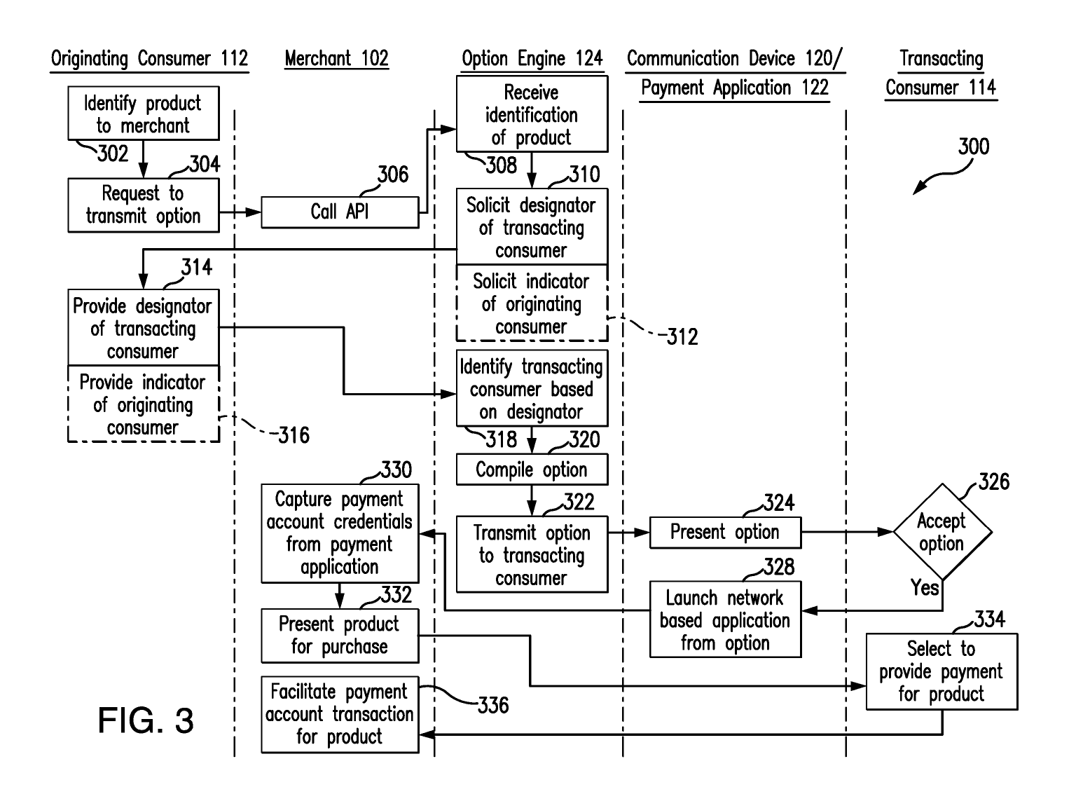

FIG. 3 illustrates an exemplary method 300 for use in facilitating a payment account transaction to a payment account, via a virtual wallet, based on an option for a product selected by an originating consumer at a merchant and transmitted to a transacting consumer. The exemplary method 300 is described with reference to the system 100 and the computing device 200. However, it should be understood that the method 300 is not limited to the system 100 or the computing device 200. And, likewise, the systems and the computing devices herein should not be understood to be limited to the exemplary method 300.

In one example, the originating consumer 112 is shopping at the merchant 102 and identifies a desired product to be purchased by the transacting consumer 114. In doing so, the originating consumer 112 identifies the product to the merchant 102, at 302. In particular, for example, the originating consumer 112 may select the product at a website associated with the merchant 102 (e.g., at the terminal 116 or at another computing device 200 accessible by the originating consumer 112, etc. via a product catalog; etc.), or the originating consumer 112 may obtain the product at the merchant 102 and present the product(s) to the terminal 116 (e.g., scan a barcode or a quick response (QR) code associated with the product, etc.), or the originating consumer 112 may otherwise indicate to the merchant 102 that the product is of interest and, as described herein, should be included in an option to be transmitted to the transacting consumer 114. With that said, it should be appreciated that when the product is presented to the merchant 102, but not specifically identified by the originating consumer 112 to the terminal 116, an employee of the merchant 102 may instead scan or otherwise identify the product to the terminal 116 after it is initially identified by the originating consumer 112 to the merchant 102.

In another example, the originating consumer 112 may identify a donation to be made to the merchant 102 by the transacting consumer 114. In doing so, the originating consumer 112 identifies the donation (broadly, a product) to the merchant 102, at 302. In particular, for example, the originating consumer 112 may select the desired donation at a website associated with the merchant 102 (e.g., at the terminal 116 or at another computing device 200 accessible by the originating consumer 112, etc.), or the originating consumer 112 may otherwise indicate to the merchant 102 that the donation is desired and should be included in an option to be transmitted to the transacting consumer 114.

In either case, when the originating consumer 112 identifies the product to the merchant 102, the originating consumer 112 also requests, at 304, the merchant 102 to send an option to the transacting consumer 114 for the product. This may include an input to the terminal 116 (or other computing device 200 accessible by the originating consumer 112) (e.g., an input requesting to fund a transaction for the product via a virtual wallet, etc.), or this may include a verbal indication to an employee of the merchant 102, etc. With that said, while the above describes the product being identified first and then the request for the option being made, it should be appreciated that in other embodiments the request for the option may be made by the originating consumer 112 prior to or at the same time as identifying the product to the merchant 102. In addition, it should also be appreciated that when the originating consumer 112 identifies a “product,” as referenced herein, the originating consumer 112 may identify any good, service, donation or other interaction with the merchant 102, which then is ultimately associated with a request by the originating consumer 112 for an option for the transacting consumer 114 to make a payment to the merchant 102 (be it in person at the merchant 102, via a website associated with the merchant 102, etc.).

In response to the request by the originating consumer 112 to transmit the option for the product to the transacting consumer 114, the terminal 116 (broadly, the merchant 102) calls an API associated with the option engine 124, at 306 (e.g., the API indicated by line A in FIG. 1, etc.). As will be described, through the API, the option engine 124 solicits various input parameters from the originating consumer 112 such as, for example, contact information for the transacting consumer 114 (e.g., phone number, email address, etc.), a product link for the identified product from a product catalog, an originator identification (ID) for the originating consumer 112 (e.g., name, phone number, email address, etc.), a delivery option for the product (e.g., a shipping address for the originating consumer 112, a pickup location designated by the originating consumer 112 (e.g., at the location of the merchant 102, etc.), etc.), or other information related to the purchase of the product (but not a payment credential), etc. (all, broadly parameters of the transaction). In addition, via the API, the terminal 116 provides various details of the identified product for the option such as, for example, a name of the product, a description of the product, an image of the product, a quantity of the product to be purchased, etc. (all, broadly parameters of the transaction). In turn, the option engine 124 receives the identification of the product and other details provided by the originating consumer 112, at 308, from the terminal 116.

Next in the method 300, the option engine 124 solicits, at 310 (also via the API), from the originating consumer 112 (if not included in the original request from the originating consumer 112), a designator for the transacting consumer 114 who is to ultimately receive the option. The designator may include any suitable indicator for use in contacting the transacting consumer 114 such as, for example, a phone number associated with the communication device 120 of the transacting consumer 114, an email address for the transacting consumer 114, etc. In connection therewith, the option engine 124 may cause an interface to display at the terminal 116 (or other computing device 200 being accessed by the originating consumer 112), via the API, requesting the designator (e.g., from the originating consumer 112, from the employee associated with the merchant 102, etc.).

In addition via the API, the option engine 124 may solicit, from the originating consumer 112, additional information for either (or both) the originating consumer 112 and the transacting consumer 114 (e.g., name, contact information, etc.) (again, if not already included in the original request). For example, as indicated by the dotted box in FIG. 3, the option engine 124 may additionally solicit, at 312, an indicator associated with the originating consumer 112, such as, for example, a name and/or contact information (e.g., phone number, email address, etc.), so that the transacting consumer 114 may be informed of the person sending the option, as described more below. In addition, and again if not already included in the original request, the option engine 124 may solicit a delivery option for the product from the originating consumer 112 (e.g., a shipping address for the originating consumer 112, an indication that the originating consumer 112 desires to pick the product up within the merchant 102, etc.).

The originating consumer 112 then provides the designator for the transacting consumer 114 to the merchant 102, at 314 (e.g., to the terminal 116, etc.). And, as further indicated by the dotted box in FIG. 3, when the additional information for the originating consumer 112 and/or the transacting consumer 114 is solicited by the option engine 124, the originating consumer 112 also provides such additional information to the merchant 102, at 316 (e.g., to the terminal 116, etc.).

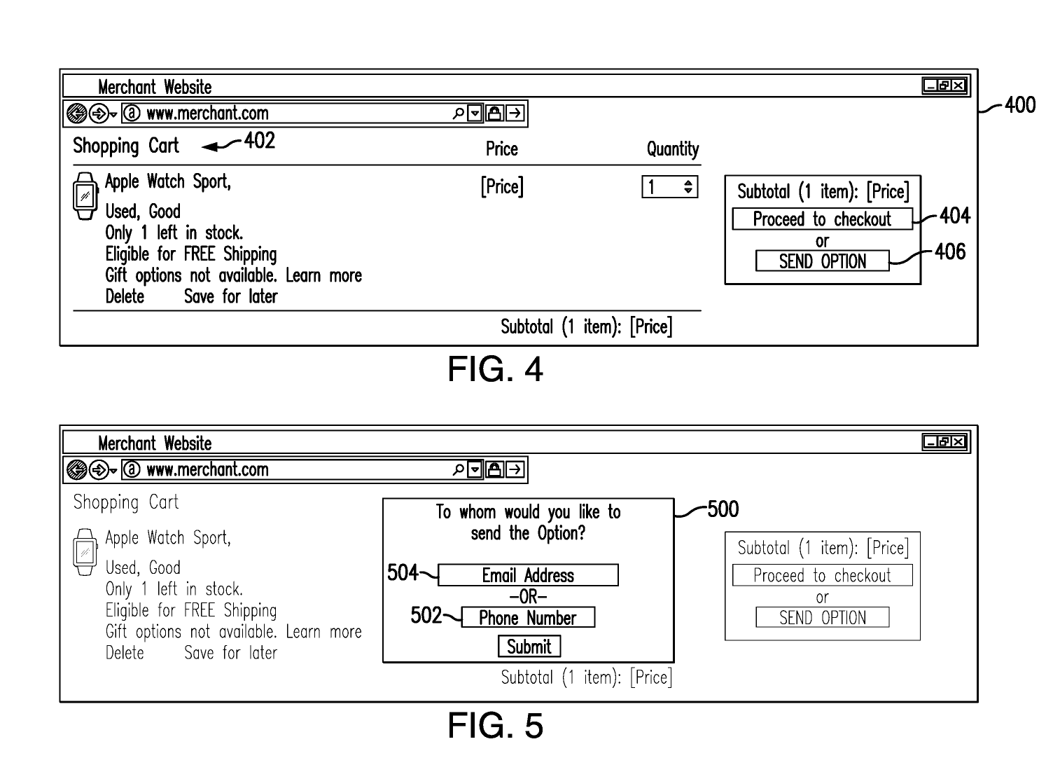

FIG. 4 illustrates an exemplary interface 400, as defined by a website associated with the merchant 102, for example, that may be displayed to the originating consumer 112 at the terminal 116 or at another computing device 200 accessible to the originating consumer 112. Through the interface 400, the originating consumer 112 may identify a product to be sent, via an option, to the transacting consumer 114. In particular in the interface 400, the originating consumer 112 has identified an Apple® watch for potential purchase (e.g., at 302 in the method 300, etc.), resulting in the Apple® watch being populated into a shopping cart 402 for the originating consumer 112. In this example, the originating consumer 112 may purchase the Apple® watch directly, by selecting the “Proceed to Checkout” button 404, or the originating consumer 112 may transmit an option for the Apple® watch to the transacting consumer 114 (as generally described herein), by instead selecting the “Send Option” button 406 (e.g., at 304 in the method 300, etc.). In other exemplary interfaces, other checkout options may be presented, for example, options to purchase selected products with virtual wallets, where the consumers may then select desired virtual wallets for use to purchase the selected products (e.g., their own virtual wallets, other transacting consumers' virtual wallets, etc.). But regardless of the form of the interfaces, the operations for providing the options to other transacting consumers are generally consistent.

FIG. 5 illustrates an exemplary interface 500, which may be displayed to the originating consumer 112 at the terminal 116, for example, through the merchant's website, upon selection of the “Send Option” button 406 in the interface 400 of FIG. 4 (e.g., via the API call at 306 in the method 300, etc.). In this example, the interface 500 solicits a phone number for and/or an email address of the transacting consumer 114, at fields 502 and 504 respectively (e.g., at 310 in the method 300, etc.). In turn, through the interface 500, the originating consumer 112 is able to provide the solicited information (e.g., at 314 in the method 300, etc.). It should be appreciated that the engine 124 may solicit more or less or different information from the originating consumer 112, to facilitate the option, through the interface 500 and/or through one or more other interfaces, as desired.

The example interfaces 400 and 500 shown in FIGS. 4 and 5 are described above as being presented to the originating consumer 112 based on the originating consumer 112 interacting with the merchant's website (e.g., when interacting with a virtual location of the merchant 102, when accessing the merchant's website via the terminal 116 at the merchant 102, etc.). However, other interfaces may be displayed to the originating consumer 112 in other embodiments. In addition, it should also be appreciated that the same interfaces 400 and 500, or different interfaces, may be displayed to the originating consumer 112 at the terminal 116, for example, when the terminal 116 includes a POS terminal and when the originating consumer 112 is interacting with the POS terminal at the merchant's physical location. For example, when the terminal 116 includes a POS terminal, the originating consumer 112 may initiate a virtual wallet transaction for the product via his/her communication device (e.g., by tapping his/her communication device at the POS terminal, etc.). In response, the POS terminal may display an interface to the originating consumer 112 soliciting an identification of the actual virtual wallet to use for the transaction. And, when the originating consumer 112 desires to request the transacting consumer 114 to fund the transaction for the product (e.g., selects an option at the POS terminal to fund the transaction with someone else's virtual wallet, etc.), the POS terminal proceeds as described herein to provide an option for the product to the transacting consumer 114. Alternatively, when the originating consumer 112 desires to use his/her virtual wallet to fund the transaction for the product (e.g., selects an option at the POS terminal to fund the transaction with his/her own virtual wallet, etc.), the transaction proceeds as is generally conventional with the originating consumer's virtual wallet used to fund the transaction (potentially via interaction with the wallet platform feature of the option engine 124).

Referring again to FIG. 3, once the designator for the transacting consumer 114 (and any additional information solicited by the option engine 124) is received by the option engine 124 (via the API), the option engine 124 identifies the transacting consumer 114, at 318, based on the designator (and any additional information, as relevant). In this exemplary embodiment, the option engine 124 searches in the data structure 126 comprising the virtual wallet participants (as associated with the option engine 124) (i.e., a virtual wallet data structure), for the virtual wallet 122 specifically associated with the transacting consumer 114. For example, and as described above, when the transacting consumer 114 registers to the virtual wallet 122, the transacting consumer 114 enters contact information, such as, for example, his/her phone number, email address, etc., which is stored in the data structure 126 (e.g., by the option engine 124, etc.) in association with an application ID for the consumer's virtual wallet 122. The option engine 124 then identifies the virtual wallet 122 for the transacting consumer 114 in the data structure 126 based on the designator received from the originating consumer 112. With that said, it should be appreciated that the designator for the transacting consumer 114 may include information other than contact information (e.g., other than phone number, email address, etc.), yet still be indicative of the transacting consumer 114 (and still be used to identify the transacting consumer 114 in the data structure 126, and his/her corresponding virtual wallet 122).

Then, once the transacting consumer 114 is identified, the option engine 124 compiles an option for the identified product, at 320. In so doing, for example, the option engine 124 may add the product to a shopping cart for the transacting consumer 114 (along with other products potentially identified by the originating consumer 112), at the virtual wallet 122. Alternatively, the option engine 124 may provide a product link for the product through which the transacting consumer 114 can elect to purchase the product, for example, via the virtual wallet 122 (or otherwise). In either case (and without limitation of the actual form of the option), the compiled option generally includes a complete “offer” for the transacting consumer 114 to purchase the product, but does not include payment account credentials to fund the purchase (e.g., the compiled offer is generally complete except for payment account credentials for a payment account associated with the virtual wallet 122, etc.). Then, the option engine 124 in turn transmits the option (be it through a shopping cart or a particular product link), at 322, to the transacting consumer 114 and, more specifically, to the virtual wallet 122 associated with the transacting consumer 114 (at the communication device 120).

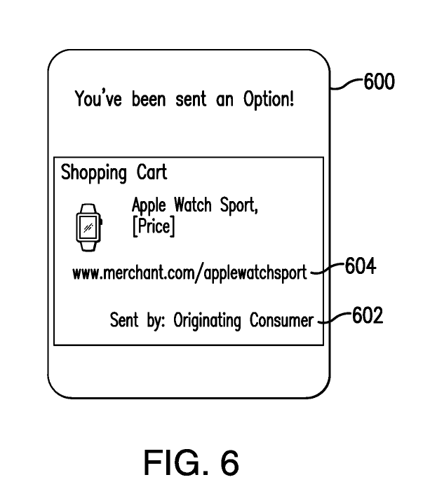

In response, upon receiving the option, the virtual wallet 122 presents the option to the transacting consumer 114, at 324. In particular, in this exemplary embodiment, the virtual wallet 122 causes a ding, tone, vibration, etc. (broadly, a notification), which causes the transacting consumer 114 to become aware of the option. And, when the transacting consumer 114 selects the virtual wallet 122 (to view additional details for the option, etc.), the virtual wallet 122, via the communication device 120 (e.g., via the presentation unit 206, etc.), presents the option to the transacting consumer 114. FIG. 6 illustrates an exemplary option interface 600, which may be displayed to the transacting consumer 114 (via the virtual wallet 122 and communication device 120) to present an option for the Apple® watch (as identified by the originating consumer 112 in the interface 400 of FIG. 4) to the transacting consumer 114. As shown, the option interface 600 includes an indication 602 of the originating consumer 112, who sent the option, and also a link 604, which may be selected by the transacting consumer 114 to view the Apple® watch and potentially perform a transaction for the Apple® watch (e.g., upon approval of the option, etc.). As described above (and while not shown in FIG. 6), the transacting consumer 114 may also be provided with details of the delivery option specified by the originating consumer 112.

Next in the method 300, when the transacting consumer 114 accepts the option, at 326, by selecting the option (e.g., by selecting the link 604 in the option interface 600, etc.), the communication device 120 launches, at 328, a network-based application, which may be generic and directed to a website associated with the selected product or which may be specific to the merchant 102 (e.g., as defined by the link 604 in the option interface 600, etc.). In response, the merchant 102 (and specifically, the launched network-based application) may capture, at 330, the payment account credential(s) for the payment account associated with the transacting consumer 114 from the virtual wallet 122 (such that the payment account credential(s) may then be used to facilitate the purchase transaction for the product identified in the offer (which, as described above, was generally a complete offer for the product but was simply lacking such credential(s)). Alternatively, in response to the acceptance/approval of the purchase option by the transacting consumer 114, the virtual wallet 122 (via the option engine 124) may provide the payment account credential(s) to the merchant 102 (e.g., via the API described above and identified at line A in the system 100, etc.). And, at 332, the merchant 102 presents the product identified by the originating consumer 112 to the transacting consumer 114, in the network-based application. Because the payment account credentials for the transacting consumer's payment account are captured, by the merchant 102, from the virtual wallet 122 (or provided by the virtual wallet 122 to the merchant 102), in this embodiment, the merchant 102 is able to populate the payment account credentials in the website, thereby permitting the transacting consumer 114 to provide payment in connection with the product, as desired, without having to actually enter payment account credentials or provide any details for the transaction (i.e., the transacting consumer 114 merely needs to approve the transaction for it to be funded thereby and proceed).

Finally, when the transacting consumer 114 desires to complete the transaction in connection with the selected product, the transacting consumer 114 selects to provide payment to the merchant 102 via his/her payment account (through the virtual wallet 122), at 334. In various embodiments, the merchant 102 may instead wait to capture the payment account credentials for the payment account associated with the transacting consumer 114, from the virtual wallet 122 (and/or the virtual wallet 122 may wait to provide the payment account credentials to the merchant 102), until the transacting consumer 114 actually selects to provide payment to the merchant 102, at 334 (instead of capturing the credentials in advance, as generally described above). In any case, once the transacting consumer 114 approves the transaction, the merchant 102 then facilitates the transaction for the product, at 336, funded by the transacting consumer's payment account. In other words, the transacting consumer 114 is able to facilitate the transaction for the product by simply selecting the option and/or providing a confirmation to proceed with a transaction for the product identified in the option, without providing any additional information regarding the product or the purchase of the product. The payment account transaction proceeds in substantially the same manner as described for the example transaction in the system 100 (and with reference to path B in FIG. 1). It should be appreciated that at any time in the method 300, prior to actually facilitating the payment account transaction for the product, the transacting consumer 114 may terminate the option and decline the transaction.

In view of the above, the systems and methods herein provide a mechanism for consumers to suggest products to other consumers, where the other consumers can then make decisions to submit payment for the products, or not. In particular, originating consumers are allowed to identify desired products and transmit options to transacting consumers to selectively provide payment for the products. As such, the methods and systems herein provide convenient manners for the originating consumers to suggest and/or facilitate payment for the products, through collaboration with the transacting consumers (and, for example, in some embodiments, through communication between their virtual wallets, etc.) (and for limiting transactions to their payment accounts to only those approved by the transacting consumers). What's more, the systems and methods herein are applicable to any merchants configured to accept transactions through virtual wallets, and are not necessarily limited to any particular merchants or consumers enrolled in particular merchant accounts. They are also applicable to any desired virtual wallets via communication with the option engine 124.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving, via an application programming interface (API), from an originating consumer, an identification of a purchase transaction for a product at a merchant; (b) soliciting, from the originating consumer, a designator for a funding user to fund the purchase transaction for the product, the designator indicative of a virtual wallet associated with the funding user; (c) compiling a purchase option for the product including multiple parameters for the purchase transaction, the multiple parameters including a delivery option for the product identified by the originating consumer but not a payment account credential for funding the purchase transaction; (d) transmitting, via the virtual wallet, the purchase option to the funding user; (e) in response to an approval of the purchase option by the funding user, providing a payment account credential associated with the virtual wallet, via the API, to the merchant, thereby permitting the merchant to initiate the purchase transaction for the product; (f) presenting the purchase option to the funding user at a communication device including the virtual wallet; (g) launching a network-based application, at the communication device, in response to a selection of a link by the funding user included in the purchase option; and (g) identifying the funding user in a data structure associated with the computing device based on the designator.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include, without limitation, a good, a service, a donation, a utility, etc.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for use in facilitating a payment account transaction via a virtual wallet, the method comprising:
receiving, at a computing device, via an application programming interface (API), from an originating consumer, an identification of a transaction for a product at a merchant;
soliciting, by the computing device, from the originating consumer, a designator for a funding user to fund the transaction for the product, the designator indicative of a virtual wallet associated with the funding user;
compiling, by the computing device, a purchase option for the product including multiple parameters for the transaction, the multiple parameters including a delivery option for the product identified by the originating consumer but not a payment account credential for funding the purchase transaction;
transmitting, by the computing device, via the virtual wallet, the purchase option to the funding user; and
in response to an approval of the purchase option by the funding user, providing a payment account credential associated with the virtual wallet, via the API, to the merchant, thereby permitting the merchant to initiate the transaction for the product to a payment account of the funding user associated with the payment account credential.

2. The method of claim 1, wherein the product includes a good or service offered by the merchant; and
wherein the multiple parameters for the transaction further include a quantity of the product.

3. The method of claim 1, further comprising:
presenting, by the computing device, the purchase option to the funding user at a communication device including the virtual wallet; and
launching a network-based application, at the communication device, in response to a selection of a link by the funding user included in the purchase option.

4. The method of claim 3, further comprising soliciting, by the computing device, an indicator associated with the originating consumer; and
wherein presenting the purchase option to the funding user includes presenting the indicator associated with the originating consumer.

5. The method of claim 1, further comprising identifying, by the computing device, the funding user in a data structure associated with the computing device based on the designator.

6. The method of claim 5, wherein compiling the purchase option includes appending a link for the product at the merchant to the purchase option, appending a description of the product to the purchase option, and appending an indicator associated with the originating consumer to the purchase option.

7. The method of claim 1, wherein the designator includes a phone number associated with a communication device, and
wherein the communication device includes a smartphone comprising the virtual wallet.

8. A system for use in facilitating a transaction to a payment account via a virtual wallet, the system comprising a computing device configured to:
in response to a request for a transaction between an originating consumer and a merchant for a product, solicit a designator for a virtual wallet associated with a funding user to fund the transaction;
compile a purchase option for the transaction, the purchase option consisting of multiple parameters, the multiple parameters including an indication of the product and a shipping address for the product but not a payment account credential for funding the purchase transaction;
transmit the purchase option to the virtual wallet of the funding user; and
provide a payment account credential for a payment account associated with the virtual wallet to the merchant upon receipt of an approval of the purchase option from the funding user via the virtual wallet, such that the merchant is able to facilitate the purchase transaction for the product based on the payment account credential for the payment account associated with the virtual wallet and the multiple parameters, without additional information from the originating consumer.

9. The system of claim 8, further comprising a non-transitory computer readable storage media including executable instructions defining the virtual wallet, which when executed by a communication device, cause the communication device to:
display the purchase option to the funding user at the communication device; and
in response to an acceptance of the purchase option, provide the approval to the computing device.

10. The system of claim 8, wherein the product includes a donation to the merchant; and
wherein merchant includes a charity entity.

11. The system of claim 8, wherein the computing device is further configured, in connection with compiling the purchase option, to append a link to the purchase option associated with the merchant, append a description of the product to the purchase option, and append an indicator associated with the originating consumer to the purchase option.

12. The system of claim 8, wherein the computing device is further configured to:
solicit an indicator associated with the originating consumer; and
append the indicator to the purchase option, such that the originating consumer is indicated to the funding user upon presentation of the purchase option to the funding user.

13. The system of claim 8, further comprising a non-transitory computer readable storage media including executable instructions defining the virtual wallet, which when executed by a communication device associated with the funding user, cause the communication device to:
present the option to the funding user; and
launch a network-based application in which the funding user is able to view a website associated with the merchant and specific to the purchase option.

14. The system of claim 8, wherein the computing device is configured, in connection with compiling the purchase option, to append the product associated with the merchant to a shopping cart included in the purchase option, whereby the funding user is able to select the shopping cart from the purchase option and facilitate the purchase transaction for the product through the payment account associated with the virtual wallet.

15. A computer-readable storage media including executable instructions for facilitating a transaction to a payment account through a virtual wallet, which when executed by at least one processor, cause the at least one processor to:
solicit, from an originating consumer, a designator for a funding user desired to fund a payment account transaction for a product at a merchant, the designator indicative of a virtual wallet associated with the funding user and including at least one of: a phone number for a communication device associated with the funding user and an electronic mail address for the funding user;
solicit an indicator associated with the originating consumer;
compile a purchase option for the product including multiple parameters for the payment account transaction, the multiple parameters including a description of the product, the indicator associated with the originating consumer and a delivery option for the product, but not including a payment account credential for funding the purchase transaction;
identify, in a virtual wallet data structure, based on the designator, the communication device associated with the funding user and enabled with the virtual wallet;
transmit the purchase option for the product to the communication device associated with the funding user, via the virtual wallet; and
in response to an approval of the purchase option by the funding user, provide a payment account credential associated with the virtual wallet, via an application programming interface (API), to the merchant, thereby permitting the merchant to initiate the purchase transaction for the product.

16. The computer-readable storage media of claim 15, wherein the purchase option includes a link to a website associated with the merchant.

17. The computer-readable storage media of claim 16, wherein the executable instructions, when executed by the at least one processor in connection with compiling the purchase option for the product, cause the at least one processor to append the link to the purchase option.

18. The computer-readable storage media of claim 16, wherein the executable instructions, when executed by the at least one processor, further cause the at least one processor to launch a network-based application, at the communication device associated with the funding user, in response to a selection of the link by the funding user, through which the funding user is able to approve the purchase option and facilitate the payment account transaction for the product.

19. The computer-readable storage media of claim 16, wherein the product is selected from the group consisting of: a good offered for sale by the merchant, a service offered for sale by the merchant, and a donation to the merchant.

20. The computer-readable storage media of claim 15, wherein the executable instructions, when executed by the at least one processor in connection with compiling the purchase option for the product, cause the at least one processor to append the product to a shopping cart included in the purchase option, whereby the funding user is able to select the shopping cart from the purchase option and facilitate the payment account transaction for the product.
